(19) United States
(12) Patent Application Publication
(10) Pub. No.: US 2015/0066574 A1
(43) Pub. Date: Mar. 5, 2015

(54) BUSINESS OPERATION PROCESSING SYSTEM, METHOD OF GENERATING PROCESSING RELATED TO A BUSINESS OPERATION, AND COMPUTER-READABLE NON-TRANSITORY STORAGE MEDIUM

(71) Applicant: HITACHI, LTD., Tokyo (JP)

(72) Inventors: Yoshiki MATSUURA, Tokyo (JP); Tetsuro ABE, Tokyo (JP); Tatsuhiko MIYATA, Tokyo (JP); Motoki YONEYAMA, Tokyo (JP)

(73) Assignee: HITACHI, LTD., Tokyo (JP)

(21) Appl. No.: 14/330,388

(22) Filed: Jul. 14, 2014

(30) Foreign Application Priority Data
Aug. 27, 2013 (JP) 2013-175201

(51) Int. Cl. G06Q 10/06

(52) U.S. Cl. CPC G06Q 10/0633
USPC 705/7.27

(57) ABSTRACT

A business operation processing system holds business operation flow model management information in which a business operation flow model indicating an order of elements that are executed in a business operation of the type is registered, and merchandise business operation flow processing management information in which an article of merchandise, a merchandise configuration indicating whether the article of merchandise is prerequisite merchandise or optional merchandise, and a merchandise business operation flow are registered. The merchandise business operation flow processing management information having registered therein a business operation processing relation between business operation processing of the optional merchandise and the optional merchandise. Business operation processing of the optional merchandise business operation flow is executed in a manner determined by its relation to business operation processing of the prerequisite merchandise that is registered as the business operation processing relation.

### CLAIM OF PRIORITY

The present application claims priority from Japanese patent application JP 2013-175201 filed on Aug. 27, 2013, the content of which is hereby incorporated by reference into this application.

### BACKGROUND

This invention relates to a business operation processing system for generating processing related to a business operation.

JP 2009-163497 A is given as the background art in the technical field of this invention. This patent publication refers to the following description: “An apparatus is configured so as to set a component part, which is created based on a merchandise model, and an office work flow, which is generated based on office work processing rules, separately from and independently of each other. The apparatus determines an office work flow model to be employed based on definition information about an office work flow which has been input, reads information of the selected office work flow model out of an office work flow model database, and embeds the definition information in an undefined item of the read office work flow model to generate an office work flow model. The apparatus next reads, for each process, a component part accessed by the process out of a component part database, and associates the component part with the process.” (See “Abstract”.)

JP 2009-163497 A also refers to the following description: “The invention is capable of defining an office work flow for performing one office work processing procedure by accessing each component part in parallel with the generation of a component part, such as settlement claim validity checking logic, which is generated from a merchandise model for designing merchandise. Therefore, when an office work flow alone is to be changed, there is no need to change component parts and separating what is to be changed from the rest is easy.” (See [0007].)

### SUMMARY

An article of merchandise can be sold in a mode chosen out of a mode in which the merchandise is sold alone and a mode in which the merchandise is sold as an accessory to another article of merchandise (as optional merchandise). In JP 2009-163497 A, generating a business operation flow with business operation processing in one article of merchandise defined as a component may create inconsistencies in processing in this case. For example, when merchandise A and merchandise B are purchased at the same time, simply processing in parallel a business operation flow for purchasing the merchandise A alone and a business operation flow for purchasing the merchandise B alone creates inconsistencies in the case where processing needs to be executed while synchronizing the business operation flow of the merchandise A and the business operation flow of the merchandise B, or in the case where processing of the merchandise A and the processing of the merchandise B need to be integrated into one.

In such cases as this where a business operation flow for selling an article of merchandise in combination with another article of merchandise differs from when business operation flows for selling the combination of articles of merchandise separately are simply processed in parallel with each other, the issue of inconsistencies can be dealt with by newly designing a business operation flow model for selling the articles of merchandise in combination. However, when there are many combinations of articles of merchandise to be sold, an accordingly large number of business operation flow models need to be designed, which is not efficient. In the case where an overall business operation flow for all articles of merchandise to be sold in combination is implemented by processing in series the respective business operation flows of the articles of merchandise to be sold in combination, if processing that takes time to complete (for example, phone/communication line installation work) is included in a business operation flow of one of the processing procedures, the overall business operation flow takes long to complete as well, which is not practical.

This invention has been made in view of the above, and an object of this invention is therefore to provide a business operation processing system that enables one to design components of an overall business operation flow for all articles of merchandise to be sold in combination without being aware of the combination of articles of merchandise to be sold together.

According to an aspect of the present invention, there is provided a business operation processing system for generating processing that is related to a business operation, the business operation processing system holding: business operation flow model management information in which a type of the business operation and a business operation flow model indicating an order of elements that are executed in a business operation of the type are registered in association with each other; and merchandise business operation flow processing management information in which an article of merchandise, a merchandise configuration, and a merchandise business operation flow are registered in association with one another, the merchandise configuration indicating whether the article of merchandise is prerequisite merchandise, which is sold alone, or optional merchandise, which is sold in combination with the prerequisite merchandise, the merchandise business operation flow indicating business operation processing procedures which are processing procedures executed in the respective elements of the business operation flow model, the merchandise business operation flow processing management information having registered therein a business operation processing relation between business operation processing of the optional merchandise and business operation processing of prerequisite merchandise of the optional merchandise, the business operation processing system being configured to: refer, in a case where an input of a generation request to generate processing that is related to business operations of the prerequisite merchandise and the optional merchandise is received, to the business operation flow model management information to identify the business operation flow model that is associated with a business operation type included in the generation request; refer to the merchandise business operation flow processing management information to identify, based on the identified business operation flow model, a prerequisite merchandise business operation flow, which is a merchandise business operation flow associated with prerequisite merchandise that is included in the generation request, and an optional merchandise business operation flow, which is a merchandise business operation flow associated with optional merchandise that is included in the generation request; and execute business operation processing of a next element, in a case where all business operation processing procedures of an element included in the identified prerequisite merchandise business operation flow and optional merchandise business operation flow are finished, and generate an overall business operation flow in which, business operation processing of the optional merchandise business operation flow is executed in a manner determined by its relation to business operation processing of the prerequisite merchandise that is registered as the business operation processing relation.

A brief description is now given of effects provided by the exemplary embodiment of this invention disclosed in this application. This invention enables to provide the communication system capable of decreasing a processing load imposed on a protocol processing server, and adapting to an increase in scale of a communication network constructed by data transfer apparatus.

Other objects, configurations, and effects than those described above are revealed in the following description of embodiments.

### BRIEF DESCRIPTION OF THE DRAWINGS

The present invention can be appreciated by the description which follows in conjunction with the following figures, wherein:

FIG. 1 is an explanatory diagram of a business operation processing system according to a first embodiment of this invention;

FIG. 2 is a hardware configuration diagram of a computer which implements the business operation processing system according to the first embodiment of this invention;

FIG. 3 is an explanatory diagram of a merchandise configuration management table according to the first embodiment of this invention;

FIG. 4 is a diagram illustrating in tree structures merchandise configurations in the first embodiment of this invention;

FIG. 5 is an explanatory diagram of a business operation flow model management table according to the first embodiment of this invention;

FIG. 6A and FIG. 6B are explanatory diagrams of a merchandise business operation flow processing management table according to the first embodiment of this invention;

FIG. 7 is an explanatory diagram of a business operation processing component management table according to the first embodiment of this invention;

FIG. 8 is an explanatory diagram of processing that is executed in the business operation processing system when an input of input information is received according to the first embodiment of this invention;

FIG. 9 is a flow chart of applied merchandise business operation flow generating processing which is executed by an applied merchandise business operation flow generating part according to the first embodiment of this invention, and

FIG. 10 is a flow chart of processing of a table definition assisting part according to a second embodiment of this invention.

### DETAILED DESCRIPTION OF THE EMBODIMENTS

Embodiments of this invention are described below with reference to the drawings.

### First Embodiment

A first embodiment of this invention describes an example of a business operation processing system for generating a business operation flow of an article of merchandise that has been input. The term “merchandise” means at least one of (1) a machine or the like and (2) a service that are provided to customers. A business operation flow is processing that is executed by an operator or others before a service relevant to merchandise is started.

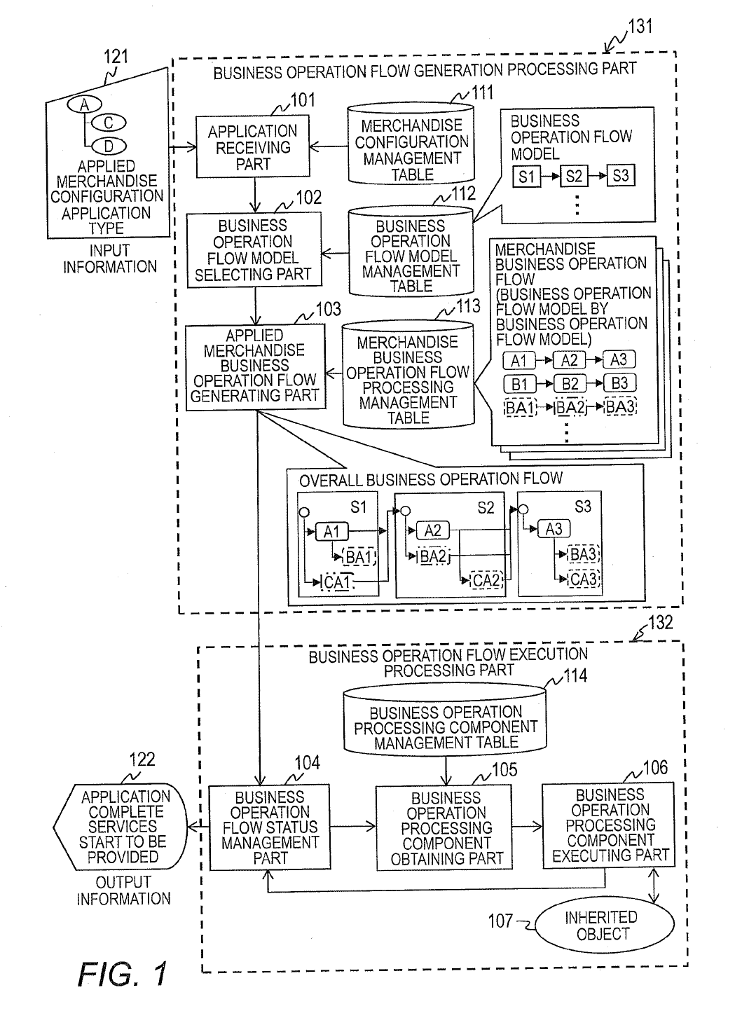

FIG. 1 is an explanatory diagram of the business operation processing system according to the first embodiment. The arrows in FIG. 1 indicate the flow of processing.

The business operation processing system includes a business operation flow generation processing part 131 and a business operation flow execution processing part 132.

The business operation flow generation processing part 131 is described first.

The business operation flow generation processing part 131 includes an application receiving part 101, a business operation flow model selecting part 102, and an applied merchandise business operation flow generating part 103, and holds tables that are used in respective processing procedures executed by these parts, namely, a merchandise configuration management table 111, a business operation flow model management table 112, and a merchandise business operation flow processing management table 113.

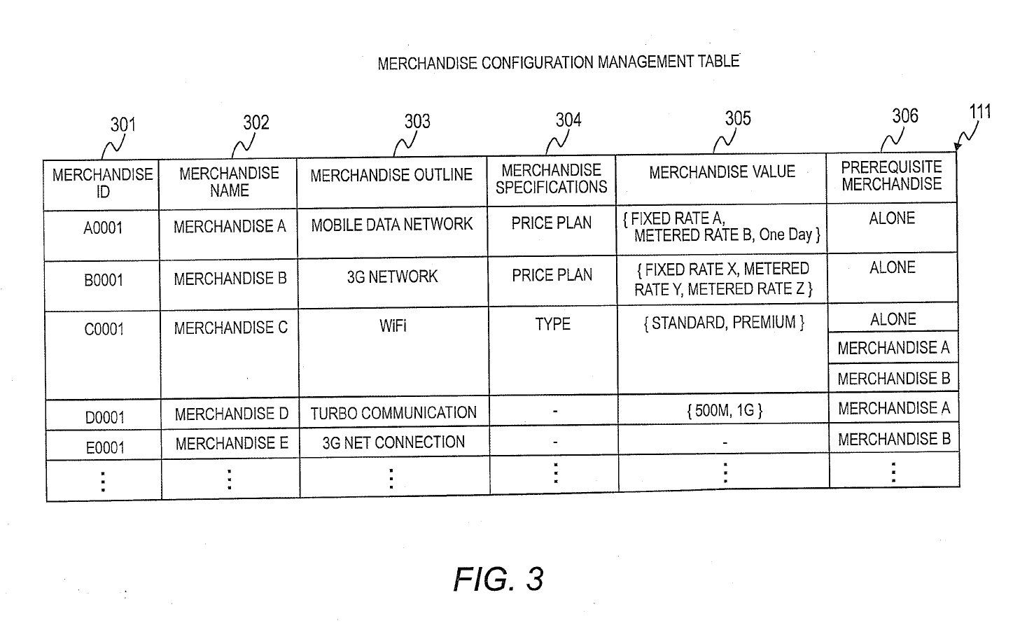

The application receiving part 101 receives an input of input information 121. The input information 121 includes an applied merchandise configuration and an application type. The applied merchandise configuration indicates a relation between articles of merchandise that are applied for (a relation such as which article of merchandise is sold alone and which article of merchandise is sold as optional merchandise to which article of merchandise). The application type indicates the type of application (for example, new application, a change to what has previously been applied for, and the cancellation of application). The application receiving part 101 refers to the merchandise configuration management table 111 to determine whether or not an applied merchandise configuration included in the received input information 121 is appropriate. The application receiving part 101 inputs the input information 121 to the business operation flow model selecting part 102 when determining that the applied merchandise configuration is appropriate and, when determining that the applied merchandise configuration is inappropriate, outputs a message to that effect and ends the processing. Details of the merchandise configuration management table 111 are described with reference to FIG. 3.

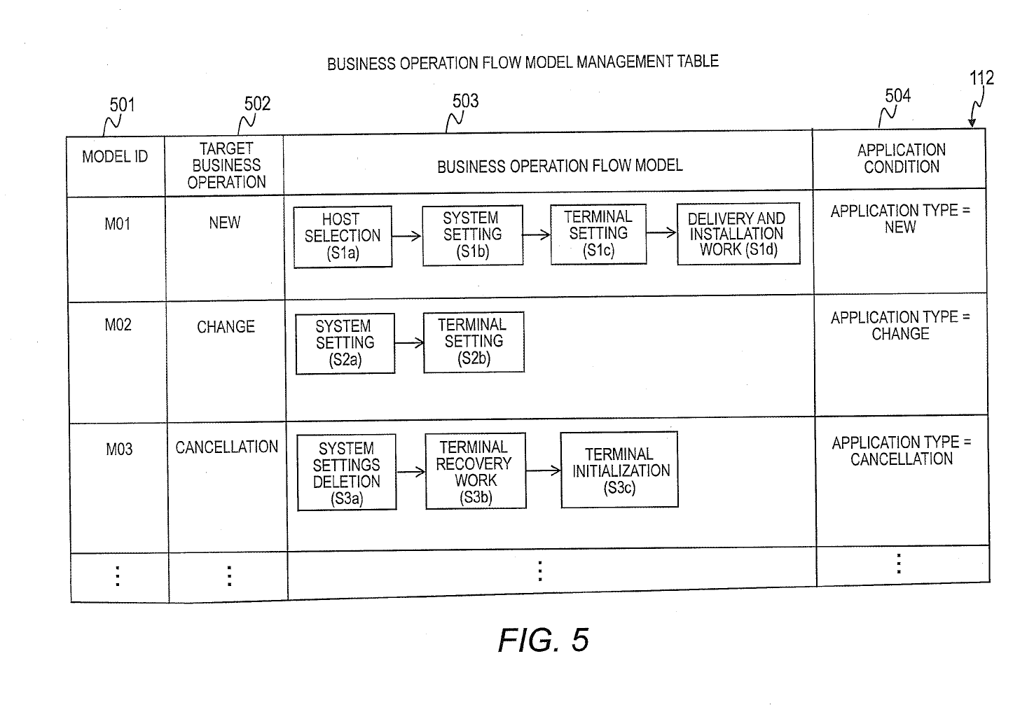

When the input information 121 is input from the application receiving part 101 to the business operation flow model selecting part 102, the business operation flow model selecting part 102 refers to the business operation flow model management table 112 to select a business operation flow model that is associated with an application type included in the input information 121. A business operation flow model indicates the execution order of elements executed in a business operation that is associated with an application type. Details of the business operation flow model management table 112 are described with reference to FIG. 5. While this embodiment deals with an example in which a business operation flow model that is associated with an application type is chosen, a pattern that fits may be identified from the customer who has applied for the merchandise, the provider of the merchandise, the customer's past utilization history, and the like to select a business operation flow model that is associated with the identified pattern.

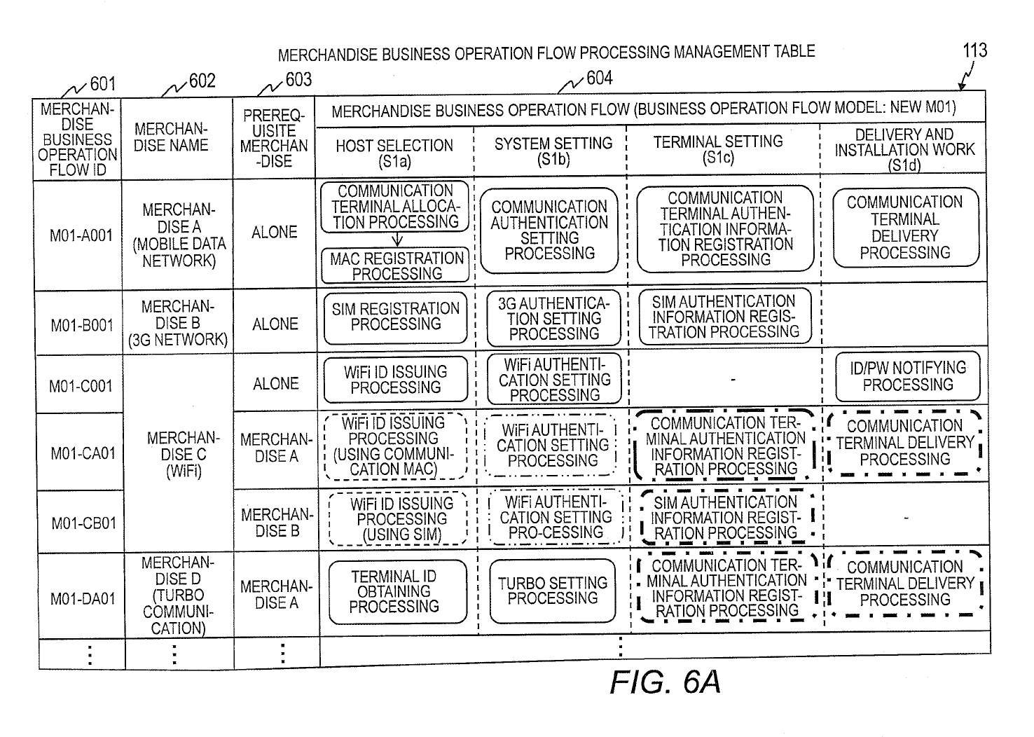

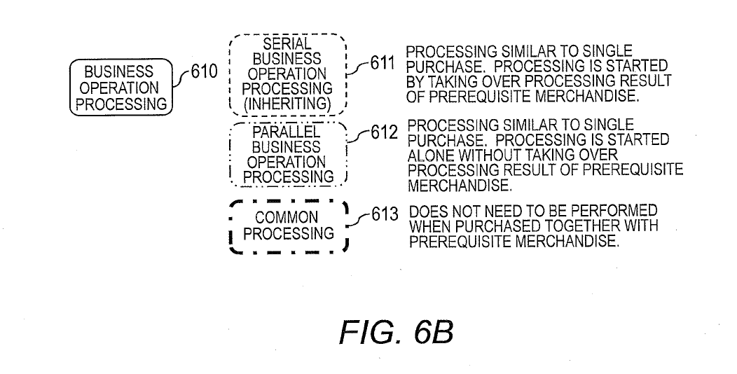

The applied merchandise business operation flow generating part 103 refers to the merchandise business operation flow processing management table 113 that is associated with the business operation flow model selected by the business operation flow model selecting part 102, and identifies a merchandise business operation flow that is associated with the applied merchandise configuration included in the input information 121. Based on the identified merchandise business operation flow, the applied merchandise business operation flow generating part 103 generates a business operation flow for all of the applied articles of merchandise (an overall business operation flow). Details of the merchandise business operation flow processing management table 113 are described with reference to FIG. 6A and FIG. 6B. A merchandise business operation flow of an article of merchandise defines, for each element in the article of merchandise, concrete processing that is executed by the element (business operation processing), and a relation between business operation processing of optional merchandise and business operation processing of its prerequisite merchandise (a business operation processing relation). As the business operation processing relation, one of “serial business operation processing”, “parallel business operation processing”, and “common processing” is registered. “Serial business operation processing” indicates that the business operation processing of the optional merchandise is processing that inherits the processing result of the business operation processing of the prerequisite merchandise to be executed after the execution of the business operation processing of the prerequisite merchandise. “Parallel business operation processing” indicates that the business operation processing of the optional merchandise is processing that is not dependent on the processing result of the business operation processing of the prerequisite merchandise, and that is executed in parallel with the business operation processing of the prerequisite merchandise. “Common processing” indicates that the business operation processing of the optional merchandise is processing that is in common with the business operation processing of the prerequisite merchandise, and that does not need to be executed once the business operation processing of the prerequisite merchandise is executed.

In this manner, an overall business operation flow is generated by determining business operation processing procedures of applied articles of merchandise with the use of the same business operation flow model, while securing consistency between the business operation processing procedures of the applied articles of merchandise depending on the applied merchandise configuration. The need to design a business operation flow model for each combination of applied articles of merchandise is thus eliminated.

In addition, the time required to execute an overall business operation flow can be cut short because business operation processing of optional merchandise can be defined as parallel business operation processing or common processing.

The business operation flow execution processing part 132 is described next.

The business operation flow execution processing part 132 includes a business operation flow status management part 104, a business operation processing component obtaining part 105, and a business operation processing component executing part 106, and holds a business operation processing component management table 114, which is used in processing of the business operation processing component obtaining part 105.

The business operation flow status management part 104 manages the processing status of an overall business operation flow generated by the applied merchandise business operation flow generating part 103. The business operation flow status management part 104 also maps, for each element of a business operation flow model, a starting trigger and process of the element to control the order of processing between business operation processing of optional merchandise and business operation processing of its prerequisite merchandise.

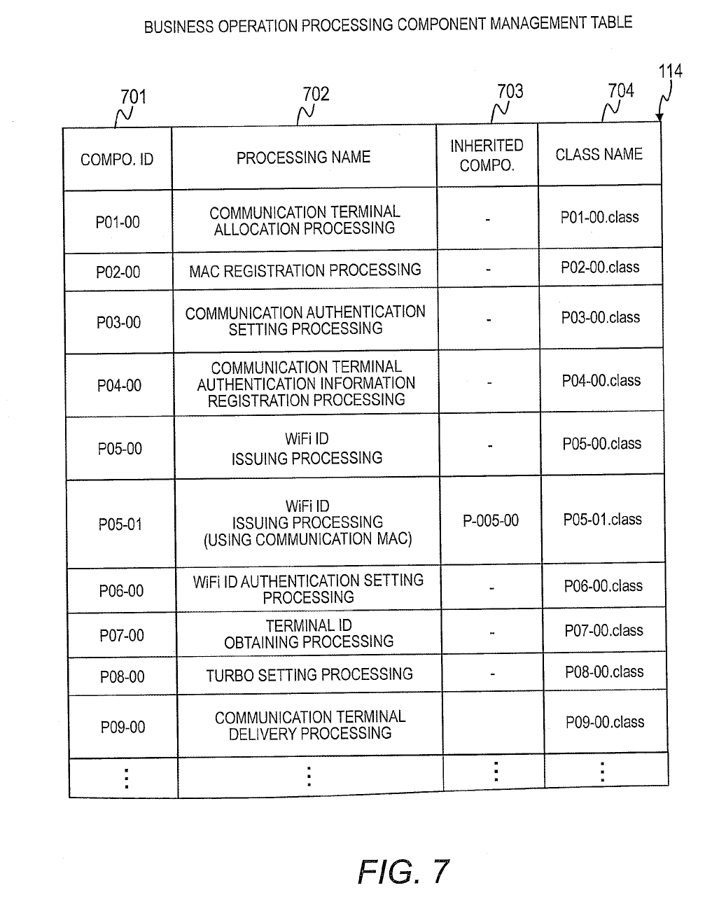

The business operation processing component obtaining part 105 refers to the business operation processing component management table 114 to obtain a component which is software for executing business operation processing that is generated by the applied merchandise business operation flow generating part 103. A component for executing business operation processing is read by the processing of the business operation processing component obtaining part 105. Details of the business operation processing component management table 114 are described with reference to FIG. 7.

The business operation processing component executing part 106 executes a component obtained by the business operation processing component obtaining part 105. A component is a program in which processing logic of business operation processing is written, and exists independently without being associated with a process, which is why the component can be called by any process. In other words, a component is a program module in the unit that can be reused by an arbitrary process.

Some components need to receive input information from the outside and output necessary output information to the outside. Examples of such components include one that suspends processing until information input by an operator is received, one that suspends processing until information notifying that merchandise shipped to a customer has been delivered is received, and one that outputs output information such as a work order for delivery, construction, or the like, or settings information to an external system.

When the execution of processing of the component is completed, the business operation processing component executing part 106 inputs component execution completion information which informs of the completion to the business operation flow status management part 104. When the component execution completion information is input to the business operation flow status management part 104, the business operation flow status management part 104 instructs the business operation processing component obtaining part 105 to obtain a component that is associated with business operation processing to be executed next, and instructs the business operation processing component executing part 106 to execute the component. After every business operation processing procedure of an overall business operation flow generated by the applied merchandise business operation flow generating part 103 is completed, services of the applied merchandise are ready to be provided and, if necessary, the business operation flow status management part 104 outputs output information 122 for informing of the readiness.

The business operation processing component executing part 106 stores, for each business operation processing procedure, in an inherited object 107, the processing result of processing of a component that is associated with business operation processing when the processing is completed, thereby enabling another business operation processing to inherit the processing result of the business operation processing procedure. The inherited object 107 stores the processing results of business operation processing procedures in the order in which the business operation processing procedures have been executed. One can therefore identify which business operation processing a processing result is about and to identify which element in an overall business operation flow the business operation processing belongs to by referring to the inherited object 107. The inherited object 107 also makes it possible to design business operation processing of optional merchandise as processing that is in common with another business operation processing procedure at the stage where business operation processing is designed for each article of merchandise.

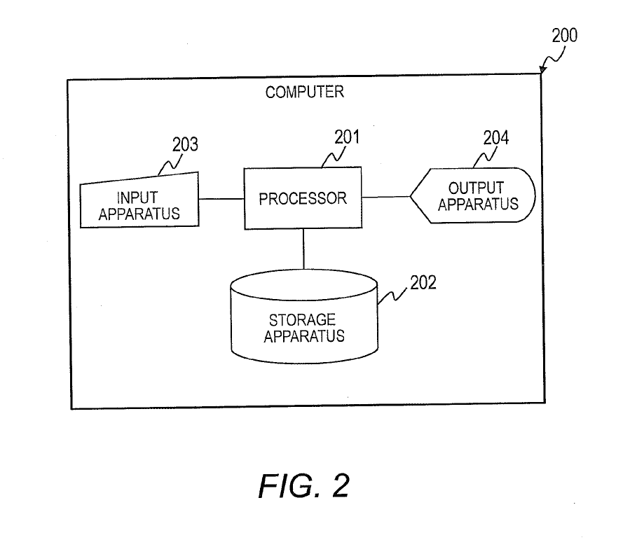

FIG. 2 is a hardware configuration diagram of a computer 200 which implements the business operation processing system according to the first embodiment.

The computer 200 includes a central control unit 201, a storage device 202, an input device 203, and an output device 204.

The storage device 202 stores the merchandise configuration management table 111, the business operation flow model management table 112, the merchandise business operation flow processing management table 113, and the business operation processing component management table 114. The central control unit 201 has a memory (not shown) which stores programs of the application receiving part 101, the business operation flow model selecting part 102, the applied merchandise business operation flow generating part 103, the business operation flow status management part 104, the business operation processing component obtaining part 105, and the business operation processing component executing part 106. The central control unit 201 executes the programs stored in the memory by referring to the tables stored in the storage device 202.

The output device 204 outputs the processing result of business operation processing, the processing result of an overall business operation flow, or the like, and outputs a screen or the like for defining a merchandise configuration, a business operation flow model, and a merchandise business operation flow. The input device 203 receives, from an operator or others, an input such as various types of data and applied merchandise via a display screen output on the output device 204 or the like.

In FIG. 2, the business operation processing system does not need to be implemented by a single computer 200, and may instead be implemented by a plurality of computers coupled via a network such as a client server system. For instance, the business operation flow generation processing part 131 and the business operation flow execution processing part 132 may be implemented by separate computers.

FIG. 3 is an explanatory diagram of the merchandise configuration management table 111 according to the first embodiment.

The merchandise configuration management table 111 is a table for managing the configuration of merchandise provided to customers.

The merchandise configuration management table 111 includes a merchandise ID 301, a merchandise name 302, a merchandise outline 303, merchandise specifications 304, a merchandise value 305, and prerequisite merchandise 306.

Identification information by which an article of merchandise can uniquely be identified is registered as the merchandise ID 301. The name of the article of merchandise is registered as the merchandise name 302. The outline of the article of merchandise is registered as the merchandise outline 303. The specifications of the article of merchandise are registered as the merchandise specifications 304. Types of values or a range of values that can be set with the specifications registered as the merchandise specifications 304 is registered as the merchandise value 305.

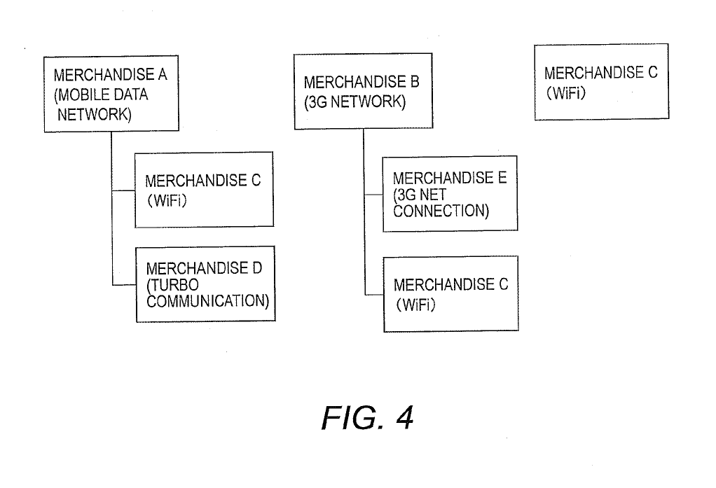

Registered as the prerequisite merchandise 306 when the article of merchandise is merchandise that is sold alone is information to that effect. In the case where the article of merchandise is optional merchandise, the name of its prerequisite merchandise is registered as the prerequisite merchandise 306. Specifically, “alone” registered as the prerequisite merchandise 306 indicates that the article of merchandise is sold alone, and the name of an article of merchandise that is registered as the prerequisite merchandise 306 indicates that the article of merchandise in question is optional merchandise sold as an accessory to the named article of merchandise. This relation regarding whether an article of merchandise can be sold alone or is optional merchandise of one of other articles of merchandise is referred to as merchandise configuration. The merchandise configurations of Merchandise A to Merchandise E registered in the merchandise configuration management table 111 of FIG. 3 are described with reference to FIG. 4. FIG. 4 is a diagram illustrating in tree structures merchandise configurations in the first embodiment.

Of Merchandise A to Merchandise E registered in the merchandise configuration management table 111, Merchandise A and Merchandise B are prerequisite merchandise which can be sold alone. Merchandise C is prerequisite merchandise, optional merchandise of Merchandise A, and optional merchandise of Merchandise B. Merchandise D is optional merchandise of Merchandise A. Merchandise E is optional merchandise of Merchandise B.

The application receiving part 101 determines that the applied merchandise configuration of the received input information 121 is appropriate when the applied merchandise configuration is a merchandise configuration registered in the merchandise configuration management table 111, and determines that the applied merchandise configuration is inappropriate when the applied merchandise configuration of the received input information 121 is not a merchandise configuration registered in the merchandise configuration management table 111. For example, in the case where the applied merchandise configuration includes optional merchandise (Merchandise E) and an article of merchandise that cannot be prerequisite merchandise of this optional merchandise (Merchandise A), the applied merchandise configuration is determined as inappropriate.

FIG. 5 is an explanatory diagram of the business operation flow model management table 112 according to the first embodiment.

The business operation flow model management table 112 is a table for managing the business operation flow model that is associated with an application type.

The business operation flow model management table 112 includes a model ID 501, a target business operation 502, a business operation flow model 503, and an application condition 504.

Identification information by which a business operation flow model can uniquely be identified is registered as the model ID 501. A business operation type that is the target of the business operation flow model is registered as the target business operation 502. A processing order of elements that construct the business operation flow model is registered as the business operation flow model 503. An application type for which the business operation flow model is selected is registered as the application condition 504.

In this embodiment, “new”, “change”, and “cancellation” are assumed as business operation types that are targets of business operation flow models, and a business operation flow model is defined for each business operation type that is the target of a business operation flow model. Business operation types that are targets of business operation flow models are not limited to “new”, “change”, and “cancellation”.

As the business operation flow model 503, a processing order of elements that construct the business operation flow model is expressed with the use of an arrow. For example, a business operation flow model having a model ID “M01” includes elements “host selection”, “system setting”, “terminal setting”, and “delivery and installation work”, and indicates that these elements are executed sequentially to complete the business operation. In the case where elements can be executed in parallel, an arrow in the business operation flow model 503 may be branched.

FIG. 6A and FIG. 6B are explanatory diagrams of the merchandise business operation flow processing management table 113 according to the first embodiment.

The merchandise business operation flow processing management table 113 is a table for managing, for each merchandise configuration (in the case of optional merchandise, for each article of merchandise that is its prerequisite merchandise), business operation processing which is concrete processing executed in elements of a business operation flow model that is registered in the business operation flow model management table 112.

FIG. 6A and FIG. 6B show the merchandise business operation flow processing management table 113 for managing business operation processing of a business operation flow model that is targeted for a business operation type “new”, and does not show the merchandise business operation flow processing management tables 113 for managing business operation processing of business operation flow models that are targeted for business operation types “change” and “cancellation”. However, the business operation flow generation processing part 131 also holds the merchandise business operation flow processing management tables 113 for managing business operation processing of business operation flow models that are targeted for business operation types “change” and “cancellation”.

The merchandise business operation flow processing management table 113 includes a merchandise business operation flow ID 601, a merchandise name 602, prerequisite merchandise 603, and a merchandise business operation flow 604.

Identification information by which a merchandise business operation flow can uniquely be identified is registered as the merchandise business operation flow ID 601. The name of merchandise that is the target of the merchandise business operation flow is registered as the merchandise name 602. A merchandise configuration is registered as the prerequisite merchandise 603. Business operation processing of elements constructing a business operation flow model is registered as the merchandise business operation flow 604. The merchandise name 602 and the prerequisite merchandise 603 are the same as the merchandise name 302 and the prerequisite merchandise 306 in the merchandise configuration management table 111 of FIG. 3.

As shown in FIG. 6B, business operation processing of an article of merchandise when the article of merchandise is optional merchandise is generally classified into processing that is the same, except for key information, as business operation processing executed when the article of merchandise is prerequisite merchandise, and processing that is the same as business operation processing of prerequisite merchandise of this optional merchandise and can therefore be shared with the business operation processing of the prerequisite merchandise (common processing 613). The processing that is the same, except for key information, as business operation processing executed when the article of merchandise is prerequisite merchandise is classified into processing that is executed by using the processing result of the business operation processing of the prerequisite merchandise (serial business operation processing 611) and processing that can be executed in parallel with the business operation processing of the prerequisite merchandise (parallel business operation processing 612). The serial business operation processing 611, the parallel business operation processing 612, and the common processing 613 indicate relations of optional merchandise to business operation processing of prerequisite merchandise, and are collectively referred to as business operation processing relations.

To set a merchandise business operation flow of optional merchandise, an administrator of the business operation processing system defines a business operation processing relation of business operation processing of the merchandise business operation flow. The administrator setting the merchandise business operation flow also registers a business operation processing procedure of a component that can be developed by inheriting a component of another business operation processing procedure in the merchandise business operation flow processing management table 113 in a manner that indicates that fact. In this embodiment, that a business operation processing procedure can inherit another business operation processing procedure is indicated by, for example, giving the same name as the inherited business operation processing procedure to the inheriting business operation processing procedure. For instance, “WiFi (trademark, the same applies hereinafter) authentication setting processing” in a record where Merchandise C is optional merchandise of Merchandise A and “WiFi authentication setting processing” in a record where Merchandise C is optional merchandise of Merchandise B indicate that a component of “WiFi authentication setting processing” that is executed when Merchandise C is prerequisite merchandise can be inherited. A component of a business operation processing procedure that can inherit another business operation processing procedure can be substituted with a component of the other business operation processing procedure, and therefore does not need to be created in the first place.

In this manner, the merchandise business operation flow processing management table 113 is used to manage, for each article of merchandise, a merchandise configuration and business operation processing, and is also used to manage, for each business operation processing procedure, a business operation processing relation and a business operation processing inheriting relation. Defining processing of a merchandise business operation flow for optional merchandise is thus simplified and the volume of designing in component design is accordingly reduced.

The number of business operation processing procedures included in a single element in a merchandise business operation flow is not limited to one, and a single element may include a plurality of business operation processing procedures which are executed sequentially or in parallel with one another.

FIG. 7 is an explanatory diagram of the business operation processing component management table 114 according to the first embodiment.

The business operation processing component management table 114 is a table for managing a component that is associated with business operation processing registered in the merchandise business operation flow processing management table 113.

The business operation processing component management table 114 includes a compo. ID 701, a processing name 702, an inherited compo. 703, and a class name 704.

Information by which a component can uniquely be identified is registered as the compo. ID 701. The name of business operation processing that is associated with the component is registered as the processing name 702. Identification information of an upper component that the processing of the component in question inherits is registered as the inherited compo. 703. The name of a class that is the substance of software of the component is registered as the class name 704.

As the processing name 702, every business operation processing type in a merchandise business operation flow registered as the merchandise business operation flow 604 in the merchandise business operation flow processing management table 113 is registered. A class name registered as the class name 704 has a format in which an extension (.class) is added to identification information registered as the compo. ID 701. However, the class name 704 is not limited to this format.

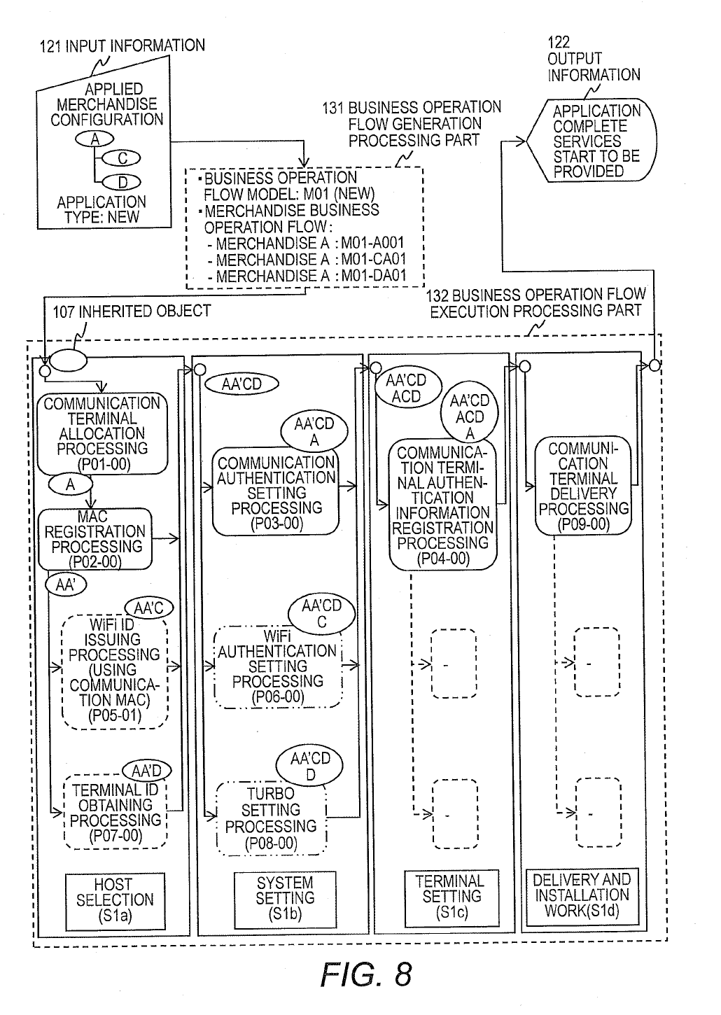

An example of processing that is executed in the business operation processing system when an input of the input information 121 is received is described next with reference to FIG. 8. FIG. 8 is an explanatory diagram of processing that is executed in the business operation processing system when an input of the input information 121 is received according to the first embodiment.

The applied merchandise configuration of the input information 121 in this example shows that Merchandise A is prerequisite merchandise that have Merchandise C and Merchandise D as optional merchandise. The application type of the input information 121 in this example is “new”.

Receiving an input of the input information 121, the application receiving part 101 first refers to the merchandise configuration management table 111 to determine whether or not the applied merchandise configuration of the input information 121 is appropriate. The applied merchandise configuration of the input information 121 here is determined as appropriate because “alone” is registered as the prerequisite merchandise 306 in a record of the merchandise configuration management table 111 where Merchandise A is registered as the merchandise name 302, “Merchandise A” is registered as the prerequisite merchandise 306 in a record of the merchandise configuration management table 111 where Merchandise C is registered as the merchandise name 302, and “Merchandise A” is registered as the prerequisite merchandise 306 in a record of the merchandise configuration management table 111 where Merchandise D is registered as the merchandise name 302.

When the applied merchandise configuration of the input information 121 is determined as appropriate, the business operation flow model selecting part 102 refers to the business operation flow model management table 112 to select a business operation flow model that is associated with the application type of the input information 121, “new” (the business operation flow model M01). Specifically, the business operation flow model selecting part 102 searches for a record of the business operation flow model management table 112 where “new” is registered as the application condition 504, and obtains identification information registered as the model ID 501 in the record, “M01”.

Next, the applied merchandise business operation flow generating part 103 refers to the merchandise business operation flow processing management table 113 that is associated with the business operation flow model selected by the business operation flow model selecting part 102 (M01) to obtain merchandise business operation flows that are associated with Merchandise A and Merchandise C and Merchandise D, which are optional merchandise of Merchandise A. Specifically, the applied merchandise business operation flow generating part 103 obtains a merchandise business operation flow from a record of the merchandise business operation flow processing management table 113 where “Merchandise A” is registered as the merchandise name 602 and “alone” is registered as the prerequisite merchandise 603 (M01-A001), obtains a merchandise business operation flow from a record of the merchandise business operation flow processing management table 113 where “Merchandise C” is registered as the merchandise name 602 and “Merchandise A” is registered as the prerequisite merchandise 603 (M01-CA01), and obtains a merchandise business operation flow from a record of the merchandise business operation flow processing management table 113 where “Merchandise D” is registered as the merchandise name 602 and “Merchandise A” is registered as the prerequisite merchandise 603 (M01-DA01).

The applied merchandise business operation flow generating part 103 determines, for each obtained merchandise business operation flow of the optional merchandise, whether business operation processing of the obtained merchandise business operation flow is the serial business operation processing 611, the parallel business operation processing 612, or the common processing 613 based on its business operation processing relation, and generates an overall business operation flow.

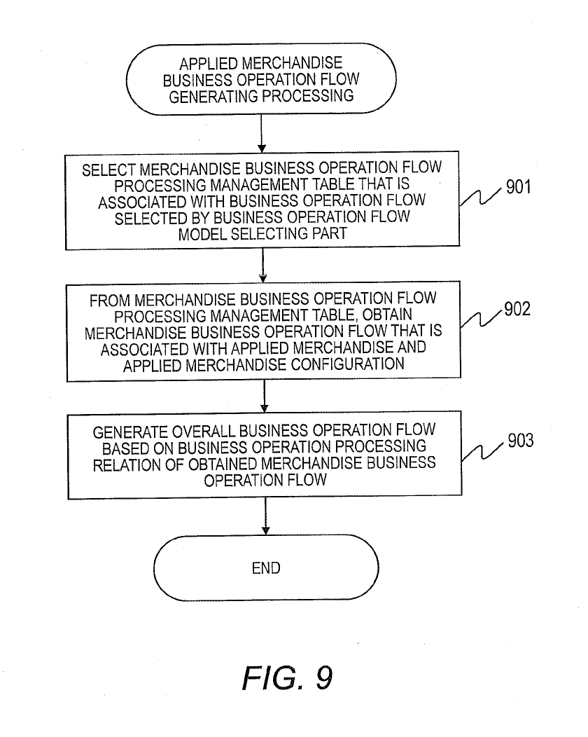

Details of the processing of the applied merchandise business operation flow generating part 103 are described with reference to FIG. 9.

The business operation flow execution processing part 132 executes, in order, elements that construct the overall business operation flow generated by the business operation flow generation processing part 131, to thereby execute the overall business operation flow. Specifically, the business operation flow status management part 104 selects an element that is a processing target and business operation processing that is a processing target based on the overall business operation flow.

The business operation processing component obtaining part 105 then refers to the business operation processing component management table 114 to obtain a component associated with the business operation processing that is the selected processing target, and calls up actual software that corresponds to the obtained component.

The business operation processing component executing part 106 executes the software called up by the business operation processing component obtaining part 105, to thereby execute the business operation processing that is the processing target, stores the result of executing the business operation processing in the inherited object 107, and notifies the business operation flow status management part 104 of the completion of the execution of the business operation processing that is the processing target.

Notified that the execution of the business operation processing that is the processing target has been completed, the business operation flow status management part 104 selects business operation processing of the processing target element that is next in the execution order as business operation processing that is a processing target, in the case where not all of business operation processing procedures of the processing target element have been executed. In the case where all of business operation processing procedures of the processing target element have been executed, on the other hand, the business operation flow status management part 104 selects the next element, if there is any, as a processing target element, and selects the first business operation processing of this element as business operation processing that is a processing target. In the case where no element is left to be selected as the next element, it means that the execution of the overall business operation flow has been completed, and the business operation flow status management part 104 outputs the output information 122 which indicates that the application has been completed and that the providing of the service can be started.

The business operation processing component executing part 106 stores processing results of business operation processing procedures in order in the inherited object 107. In this manner, the processing result of each business operation processing procedure can be inherited by another business operation processing procedure, and the business operation processing component executing part 106 can use the processing result of a business operation processing procedure in executing another business operation processing procedure by referring to the inherited object 107.

FIG. 9 is a flow chart of applied merchandise business operation flow generating processing which is executed by the applied merchandise business operation flow generating part 103 according to the first embodiment.

The applied merchandise business operation flow generating part 103 first selects the merchandise business operation flow processing management table 113 that is associated with a business operation flow model selected by the business operation flow model selecting part 102 (Step 901). The business operation flow generation processing part 131 holds the merchandise business operation flow processing management table 113 for each business operation type as described above with reference to FIG. 6A and FIG. 6B. The merchandise business operation flow processing management table 113 that is associated with a business operation flow model associated with an application type in question is therefore selected in Step 901.

The applied merchandise business operation flow generating part 103 next obtains, from the merchandise business operation flow processing management table 113 selected in Step 901, a merchandise business operation flow that is associated with applied merchandise and applied merchandise configuration in question (Step 902). Specifically, the applied merchandise business operation flow generating part 103 obtains a merchandise business operation flow from a record of the merchandise business operation flow processing management table 113 selected in Step 901 where the merchandise name 602 matches the applied merchandise and the prerequisite merchandise 603 matches the applied merchandise configuration.

The applied merchandise business operation flow generating part 103 next generates an overall business operation flow based on business operation processing relations of the merchandise business operation flow obtained in Step 902 (Step 903), and ends the processing. Specifically, the applied merchandise business operation flow generating part 103 generates an overall business operation flow so that, in the case where a business operation processing relation of optional merchandise indicates serial business operation processing, the serial business operation processing is executed at the completion of the execution of business operation processing of prerequisite merchandise that is associated with the serial business operation processing, whereas, in the case where a business operation processing relation of optional merchandise indicates parallel business operation processing, the parallel business operation processing is executed in parallel with business operation processing of prerequisite merchandise that is associated with the parallel business operation processing, and, in the case where a business operation processing relation of optional merchandise indicates common processing, business operation processing of prerequisite merchandise is executed in place of the common processing.

As described above, the business operation processing system according to this embodiment registers a business operation processing relation between business operation processing of optional merchandise and business operation processing of prerequisite merchandise of the optional merchandise in the merchandise business operation flow processing management table 113, and generates an overall business operation flow in which the business operation processing of the optional merchandise is executed in a manner determined by the business operation processing relation. An overall business operation flow in which business operation processing procedures are executed in a manner determined by business operation processing relations that fit the current combination of applied articles of merchandise is thus generated from the same merchandise business operation flow processing management table 113, no matter what combination of articles of merchandise is applied for, thereby eliminating the need to design for each combination of applied articles of merchandise a business operation flow in which business operation processing relations of the applied articles of merchandise are registered. A business operation processing system that allows one to design a business operation flow without being conscious of the combination of articles of merchandise to be sold together.

One of serial business operation processing, parallel business operation processing, and common processing is registered as a business operation processing relation, and the administrator can set business operation processing of optional merchandise suitably to serial business operation processing, parallel business operation processing, or common processing. The time required to execute an overall business operation flow can therefore be made shorter in this embodiment than when business operation processing of prerequisite merchandise and business operation processing of optional merchandise are simply executed in series. For example, in the case of processing in which business operation processing of prerequisite merchandise takes long time (e.g., processing that needs to wait for delivery or processing that needs to wait for installation work to finish), setting business operation processing of optional merchandise that is associated with the lengthy business operation processing to parallel business operation processing greatly cuts short the processing time of the overall business operation flow.

The business operation processing component management table 114 is used to manage a component that is associated with business operation processing, and the business operation flow execution processing part 132 executes business operation processing by reading a component that is associated with the business operation processing of the overall business operation flow out of the business operation processing component management table 114 and executing the read component. The specifics of business operation processing are thus implemented by a component, and business operation processing of an article of merchandise can be added or deleted by simply adding or deleting a component without needing to revise or newly develop a business operation flow, which improves development efficiency.

### Second Embodiment

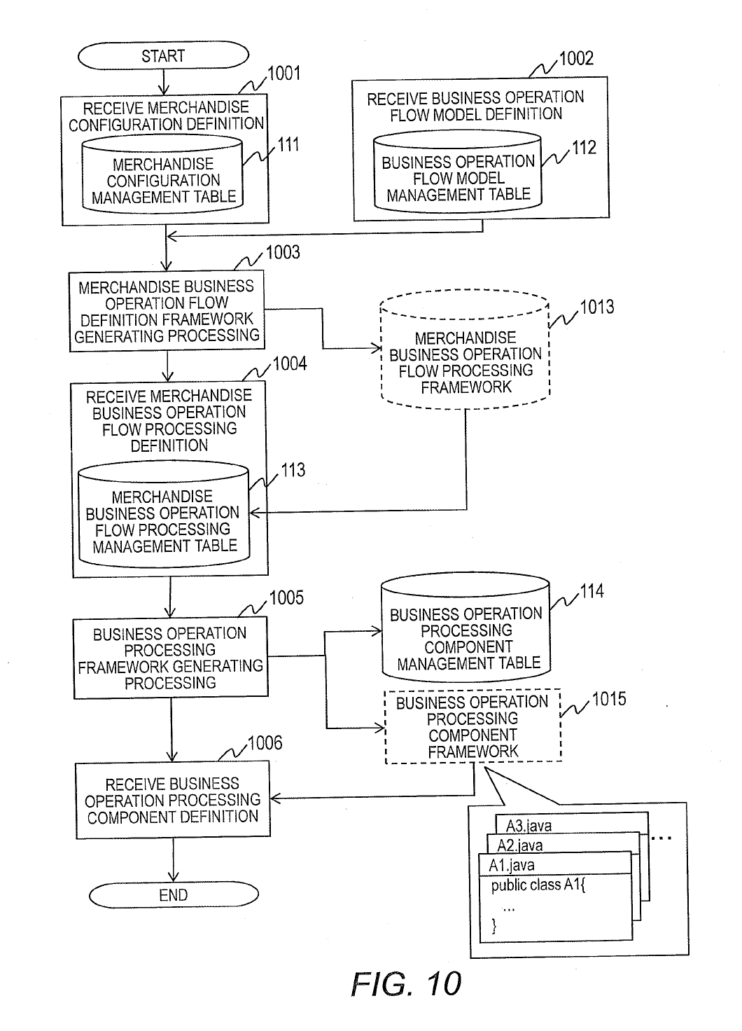

A second embodiment of this invention is described below with reference to FIG. 10.

This embodiment is about assisting an administrator in defining the merchandise business operation flow processing management table 113 and the business operation processing component management table 114 to avoid inconsistencies between the tables.

FIG. 10 is a flow chart of processing of a table definition assisting part according to the second embodiment.

The table definition assisting part executes processing of assisting the administrator in defining the merchandise business operation flow processing management table 113 and the business operation processing component management table 114. A program of the table definition assisting part is stored in the memory (not shown) of the central control unit 201 illustrated in FIG. 2. The central control unit 201 executes the program of the table definition assisting part stored in the memory, thereby implementing the table definition assisting part.

The table definition assisting part first receives an input of a merchandise configuration definition and a business operation flow model definition, registers the received merchandise configuration definition in the merchandise configuration management table 111 (Step 1001), and registers the received business operation flow model definition in the business operation flow model management table 112 (Step 1002).

A merchandise configuration definition includes the merchandise names, merchandise outlines, merchandise specifications, merchandise values, merchandise configurations, and the like of an article of merchandise that is newly provided and optional merchandise of this article of merchandise. For example, a merchandise configuration definition is input based on the type, merchandise configuration, and the like of merchandise devised by a merchandise strategy division or the like of a corporation.

A business operation flow model definition is the definition of a business operation flow model, and includes a business operation type that is the target of the business operation flow model, elements constructing the business operation flow model, and the order in which the elements are processed.

A graphical user interface (GUI) may be used to input a merchandise configuration definition and a business operation flow model definition.

Because a merchandise configuration definition is information about the merchandise configuration and a business operation flow model definition is the processing order of elements that are common to all relevant articles of merchandise, there is no dependency relation between a merchandise configuration definition and a business operation flow model definition, and ensuring consistency between these definitions is not necessary.

The table definition assisting part generates a merchandise business operation flow processing framework 1013 based on the merchandise configuration management table 111 and the business operation flow model management table 112 (Step 1003).

The merchandise business operation flow processing framework 1013 equals the merchandise business operation flow processing management table 113 of FIG. 6A and FIG. 6B in a state where business operation processing has not been input yet. The table definition assisting part generates the merchandise business operation flow processing management table 113 for each business operation flow model registered in the business operation flow model management table 112. The table definition assisting part adds to the merchandise business operation flow processing management table 113 as many records as the number of articles of merchandise registered in the merchandise configuration management table 111.

In each of the records added to the merchandise business operation flow processing management table 113, the table definition assisting part registers unique identification information as the merchandise business operation flow ID 601, registers, as the merchandise name 602, a merchandise name registered as the merchandise name 302 in the merchandise configuration management table 111, and registers, as the prerequisite merchandise 603, a merchandise configuration registered as the prerequisite merchandise 306 in the merchandise configuration management table 111. The table definition assisting part also registers, as the merchandise business operation flow 604 in the added record of the merchandise business operation flow processing management table 113, in the processing order, elements registered as the business operation flow model 503 in a record of the business operation flow model management table 112 that is associated with a business operation type associated with this merchandise business operation flow processing management table 113. In the manner described above, the table definition assisting part can generate the merchandise business operation flow processing framework 1013 that is consistent with the merchandise configuration management table 111 and the business operation flow model management table 112.

The table definition assisting part may output the generated merchandise business operation flow processing framework 1013 in the form of a GUI. The administrator inputs, for each element in each article of merchandise, a business operation processing definition of the element (a merchandise business operation flow processing definition) based on the output merchandise business operation flow processing framework 1013.

Receiving the input of a merchandise business operation flow processing definition, the table definition assisting part registers the received merchandise business operation flow processing definition in the merchandise business operation flow processing management table 113 (Step 1004).

When defining business operation processing of optional merchandise, the administrator also defines whether the business operation processing relation of the optional merchandise indicates serial business operation processing, parallel business operation processing, or common processing. In the case of a business operation processing procedure that can inherit one of other business operation processing procedures, the administrator defines the business operation processing procedure as having the same name as that of the inherited business operation processing procedure. For example, in records of the table of FIG. 6A where Merchandise C has Merchandise A and Merchandise B as its prerequisite merchandise, “WiFi authentication setting processing” can inherit “WiFi authentication setting processing” of a record where prerequisite merchandise of Merchandise C is Merchandise C itself, and there is no need to develop components in which “WiFi authentication setting processing” is written for the case where prerequisite merchandise of Merchandise C is Merchandise A and for the case where prerequisite merchandise of Merchandise C is Merchandise B.

The table definition assisting part next generates a business operation processing component framework 1015 and the business operation processing component management table 114 based on the merchandise business operation flow processing management table 113 (Step 1005).

The table definition assisting part first generates the business operation processing component management table 114 based on the merchandise business operation flow processing management table 113 generated in Step 1004. Specifically, the table definition assisting part adds to the business operation processing component management table 114 as many records as the number of business operation processing procedures in the merchandise business operation flow processing management table 113 that do not inherit other business operation processing procedures. In each of the added records of the business operation processing component management table 114, the table definition assisting part registers, as the compo. ID 701, unique identification information of a component that is associated with the business operation processing procedure, registers the name of the business operation processing procedure as the processing name 702, and registers the name of the component as the class name 704 to generate the business operation processing component management table 114. A component name registered as the class name 704 in this embodiment is created by adding an extension “.class” to identification information of the component registered as the compo. ID 701.

The table definition assisting part may output the generated business operation processing component management table 114 in the form of a GUI in order to allow the administrator to check the generated business operation processing component management table 114.

For example, in the case where a business operation processing procedure can inherit another business operation processing procedure but needs a component generated therefor, the administrator inputs the name of this business operation processing procedure and the name of the inherited business operation processing procedure to the table definition assisting part. Receiving the input of the name of the business operation processing procedure and the name of the inherited business operation processing procedure, the table definition assisting part adds a record to the business operation processing component management table 114. In the added record, the table definition assisting part registers identification information of the component as the compo. ID 701, registers the received name of the business operation processing procedure as the processing name 702, and registers the name of the component as the class name 704. The table definition assisting part then searches the business operation processing component management table 114 for a record where the input name of the inherited business operation processing procedure is registered as the processing name 702 to obtain component identification information registered as the compo. ID 701, and registers the obtained component identification information as the inherited compo. 703 in the added record.

After the business operation processing component management table 114 is generated in the manner described above, the table definition assisting part generates the business operation processing component framework 1015 which is given a name registered as the class name 704 in the business operation processing component management table 114 and which describes a programming language.

The table definition assisting part uses a program or the like to receive an input of the programming language written in the business operation processing component framework 1015 (a business operation processing component definition) and to implement the business operation processing component (Step 1006), and then ends the processing.

In this manner, the merchandise business operation flow processing management table 113 is generated based on the merchandise business operation flow processing framework 1013 that is generated so as to avoid inconsistencies with the merchandise configuration management table 111 and the business operation flow model management table 112. The business operation processing component management table 114 is generated based on this merchandise business operation flow processing management table 113, which ensures that there is no inconsistency between the business operation processing component management table 114 and the merchandise business operation flow processing management table 113. In addition, each component that is actually created is given a component name registered as the class name 704 in the business operation processing component management table 114. This prevents inconsistencies between the business operation processing component management table 114 and the actually created component.

In the case where there is an addition, a deletion, or a change in a merchandise configuration that causes a change to the merchandise configuration management table 111, the table definition assisting part can generate the merchandise business operation flow processing management table 113 and the business operation processing component management table 114 by executing Step 1003 and Step 1005 and developing only for the differential between the pre-change configuration and the post-change configuration. The work required to revise the merchandise business operation flow processing management table 113 and the business operation processing component management table 114 to accommodate a change in merchandise configuration is thus reduced.

Each of the above-mentioned embodiments is an example, and various modifications and changes may be made without departing from the gist of this invention.

This invention is not limited to the embodiment described above, and includes various modification examples. For instance, the embodiment given above is a detailed description that is written for easy understanding of this invention, and this invention is not necessarily limited to a mode that includes all the components described. Replacing some components of one embodiment with components of another embodiment is also an option. Components of one embodiment may be added with components of another embodiment. For some components in each embodiment, other components may be added or deleted or may substitute.

Some of or all of the components, functions, processing parts, processing measures, and the like described above may be implemented by hardware by, for example, designing those in the form of an integrated circuit. Alternatively, the components, functions, and the like described above may be implemented by software by having a processor interpret and execute programs that respectively implement the described functions. Programs, tables, files, and other types of information for implementing the described functions can be put in a memory, a recording device such as a hard disk or a solid state drive (SSD), or a recording medium such as an IC card, an SD card, or a DVD.

What is claimed is:

1. A business operation processing system for generating processing that is related to a business operation,
the business operation processing system holding:
business operation flow model management information in which a type of the business operation and a business operation flow model indicating an order of elements that are executed in a business operation of the type are registered in association with each other; and
merchandise business operation flow processing management information in which an article of merchandise, a merchandise configuration, and a merchandise business operation flow are registered in association with one another, the merchandise configuration indicating whether the article of merchandise is prerequisite merchandise, which is sold alone, or optional merchandise, which is sold in combination with the prerequisite merchandise, the merchandise business operation flow indicating business operation processing procedures which are processing procedures executed in the respective elements of the business operation flow model,
the merchandise business operation flow processing management information having registered therein a business operation processing relation between business operation processing of the optional merchandise and business operation processing of prerequisite merchandise of the optional merchandise,
the business operation processing system being configured to:
refer, in a case where an input of a generation request to generate processing that is related to business operations of the prerequisite merchandise and the optional merchandise is received, to the business operation flow model management information to identify the business operation flow model that is associated with a business operation type included in the generation request;
refer to the merchandise business operation flow processing management information to identify, based on the identified business operation flow model, a prerequisite merchandise business operation flow, which is a merchandise business operation flow associated with prerequisite merchandise that is included in the generation request, and an optional merchandise business operation flow, which is a merchandise business operation flow associated with optional merchandise that is included in the generation request; and
execute business operation processing of a next element, in a case where all business operation processing procedures of an element included in the identified prerequisite merchandise business operation flow and optional merchandise business operation flow are finished, and generate an overall business operation flow in which, business operation processing of the optional merchandise business operation flow is executed in a manner determined by its relation to business operation processing of the prerequisite merchandise that is registered as the business operation processing relation.

2. The business operation processing system according to claim 1,
wherein the business operation processing relation indicates one of serial business operation processing, parallel business operation processing, and common processing as the business operation processing of the optional merchandise,
wherein the serial business operation processing means that the business operation processing of the optional merchandise inherits a processing result of the business operation processing of the prerequisite merchandise and is executed after the execution of the business operation processing of the prerequisite merchandise,
wherein the parallel business operation processing means that the business operation processing of the optional merchandise is independent of the processing result of the business operation processing of the prerequisite merchandise and is executed independently of the execution of the business operation processing of the prerequisite merchandise, and
wherein the common processing means that the business operation processing of the optional merchandise is in common with the business operation processing of the prerequisite merchandise and execution of the common processing becomes unnecessary once the business operation processing of the prerequisite merchandise is executed.

3. The business operation processing system according to claim 1, wherein a business operation processing procedure that is developable by inheriting another business operation processing procedure is registered in the merchandise business operation flow processing management information in a manner that indicates that fact.

4. The business operation processing system according to claim 1,
wherein the business operation processing system further holds component management information for managing a component, which is a reusable processing logic, in association with the business operation processing, and
wherein the business operation processing system is further configured to execute a business operation of the generated overall business operation flow by referring to the component management information and reading a component that is associated with business operation processing of the generated overall business operation flow.

5. The business operation processing system according to claim 4, wherein the business operation processing system is further configured to store execution results of the business operation processing of the prerequisite merchandise and the business operation processing of the optional merchandise in the same object in an order in which the business operation processing of the prerequisite merchandise and the business operation processing of the optional merchandise are executed, to thereby inherit an execution result from one business operation processing procedure to another business operation processing procedure.

6. The business operation processing system according to claim 4, wherein, in a case where a merchandise configuration of the prerequisite merchandise and the optional merchandise and the business operation flow model of one type are input, the business operation processing system is further configured to:
register, based on the input merchandise configuration, a merchandise configuration of the merchandise business operation flow processing management information;
register, based on the input business operation flow model, elements in which business operation processing of the merchandise business operation flow processing management information is registered; and
input the business operation processing to be executed in the elements that is registered in the merchandise business operation flow processing management information, and input a business operation processing relation of this business operation processing, thereby generating the merchandise business operation flow processing management information.

7. The business operation processing system according to claim 6,
wherein the business operation processing system is further configured to:
determine, in a case where the merchandise business operation flow processing management information is generated, a name of a component that is associated with business operation processing registered in the merchandise business operation flow processing management information; and
register the business operation processing and the determined component name in association with each other in the component management information, to thereby generate the component management information, and
wherein the component is actually written with use of the determined component name.

8. A method of generating processing that is related to a business operation in a business operation processing system for generating the processing that is related to the business operation,
the business operation processing system holding:
business operation flow model management information in which a type of the business operation and a business operation flow model indicating an order of elements that are executed in a business operation of the type are registered in association with each other; and
merchandise business operation flow processing management information in which an article of merchandise, a merchandise configuration, and a merchandise business operation flow are registered in association with one another, the merchandise configuration indicating whether the article of merchandise is prerequisite merchandise, which is sold alone, or optional merchandise, which is sold in combination with the prerequisite merchandise, the merchandise business operation flow indicating business operation processing procedures which are processing procedures executed in the respective elements of the business operation flow model,
the merchandise business operation flow processing management information having registered therein a business operation processing relation between business operation processing of the optional merchandise and business operation processing of prerequisite merchandise of the optional merchandise,
the method including:
referring, by the business operation processing system, in a case where an input of a generation request to generate processing that is related to business operations of the prerequisite merchandise and the optional merchandise is received, to the business operation flow model management information to identify the business operation flow model that is associated with a business operation type included in the generation request;
referring to, by the business operation processing system, the merchandise business operation flow processing management information to identify, based on the identified business operation flow model, a prerequisite merchandise business operation flow, which is a merchandise business operation flow associated with prerequisite merchandise that is included in the generation request, and an optional merchandise business operation flow, which is a merchandise business operation flow associated with optional merchandise that is included in the generation request; and
executing, by the business operation processing system, business operation processing of a next element, in a case where all business operation processing procedures of an element included in the identified prerequisite merchandise business operation flow and optional merchandise business operation flow are finished, and generating, by the business operation processing system, an overall business operation flow in which business operation processing of the optional merchandise business operation flow is executed in a manner determined by its relation to business operation processing of the prerequisite merchandise that is registered as the business operation processing relation.

9. The method according to claim 8,
wherein the business operation processing relation indicates one of serial business operation processing, parallel business operation processing, and common processing as the business operation processing of the optional merchandise,
wherein the serial business operation processing means that the business operation processing of the optional merchandise inherits a processing result of the business operation processing of the prerequisite merchandise and is executed after the execution of the business operation processing of the prerequisite merchandise,
wherein the parallel business operation processing means that the business operation processing of the optional merchandise is independent of the processing result of the business operation processing of the prerequisite merchandise and is executed independently of the execution of the business operation processing of the prerequisite merchandise, and
wherein the common processing means that the business operation processing of the optional merchandise is in common with the business operation processing of the prerequisite merchandise and execution of the common processing becomes unnecessary once the business operation processing of the prerequisite merchandise is executed.

10. The method according to claim 8, wherein a business operation processing procedure that is developable by inheriting another business operation processing procedure is registered in the merchandise business operation flow processing management information in a manner that indicates that fact.

11. The method according to claim 8,
wherein the business operation processing system further holds component management information for managing a component, which is a reusable processing logic, in association with the business operation processing, and
wherein the method further includes executing, by the business operation processing system, a business operation of the generated overall business operation flow is executed by referring to the component management information and reading a component that is associated with business operation processing of the generated overall business operation flow.

12. The method according to claim 11, further including storing, by the business operation processing system, execution results of the business operation processing of the prerequisite merchandise and the business operation processing of the optional merchandise in the same object in an order in which the business operation processing of the prerequisite merchandise and the business operation processing of the optional merchandise are executed, to thereby inherit an execution result from one business operation processing procedure to another business operation processing procedure.

13. The method according to claim 11, further including, in a case where a merchandise configuration of the prerequisite merchandise and the optional merchandise and the business operation flow model of one type are input to the business operation processing system:
registering, by the business operation processing system, based on the input merchandise configuration, a merchandise configuration of the merchandise business operation flow processing management information;
registering, by the business operation processing system, based on the input business operation flow model, elements in which business operation processing of the merchandise business operation flow processing management information is registered; and
inputting, by the business operation processing system, the business operation processing to be executed in the elements that is registered in the merchandise business operation flow processing management information, and inputting a business operation processing relation of this business operation processing, thereby generating the merchandise business operation flow processing management information.

14. The method according to claim 13, further including:
determining, by the business operation processing system, in a case where the merchandise business operation flow processing management information is generated, a name of a component that is associated with business operation processing registered in the merchandise business operation flow processing management information; and
registering, by the business operation processing system, the business operation processing and the determined component name in association with each other in the component management information, to thereby generate the component management information, and
wherein the component is actually written with use of the determined component name.

15. A computer-readable non-transitory storage medium for storing a program causing a processor to execute processing for generating processing that is related to a business operation, in a business operation processing system having the processor and a storage area,
the business operation processing system holding, in the storage area:
business operation flow model management information in which a type of the business operation and a business operation flow model indicating an order of elements that are executed in a business operation of the type are registered in association with each other; and
merchandise business operation flow processing management information in which an article of merchandise, a merchandise configuration, and a merchandise business operation flow are registered in association with one another, the merchandise configuration indicating whether the article of merchandise is prerequisite merchandise, which is sold alone, or optional merchandise, which is sold in combination with the prerequisite merchandise, the merchandise business operation flow indicating business operation processing procedures which are processing procedures executed in the respective elements of the business operation flow model,
the merchandise business operation flow processing management information having registered therein a business operation processing relation between business operation processing of the optional merchandise and business operation processing of prerequisite merchandise of the optional merchandise,
the processing for generating processing including:
a procedure of referring, in a case where an input of a generation request to generate processing that is related to business operations of the prerequisite merchandise and the optional merchandise is received, to the business operation flow model management information to identify the business operation flow model that is associated with a business operation type included in the generation request;
a procedure of referring to the merchandise business operation flow processing management information to identify, based on the identified business operation flow model, a prerequisite merchandise business operation flow, which is a merchandise business operation flow associated with prerequisite merchandise that is included in the generation request, and an optional merchandise business operation flow, which is a merchandise business operation flow associated with optional merchandise that is included in the generation request; and
a procedure of executing business operation processing of a next element, in a case where all business operation processing procedures of an element included in the identified prerequisite merchandise business operation flow and optional merchandise business operation flow are finished, and generating an overall business operation flow in which business operation processing of the optional merchandise business operation flow is executed in a manner determined by its relation to business operation processing of the prerequisite merchandise that is registered as the business operation processing relation.
